(19) United States
(12) Patent Application Publication
(10) Pub. No.: US 2011/0074529 A1
(43) Pub. Date: Mar. 31, 2011

(54) Magnetic Strip, Sensor Comprising a Magnetic Strip and Process for the Manufacture of a Magnetic Strip

(75) Inventor: Ottmar Roth, Gruendau (DE)

(73) Assignee: Vacuumschmelze GmbH & Co., KG, Hanau (DE)

(21) Appl. No.: 12/895,793

(22) Filed: Sep. 30, 2010

Related U.S. Application Data
(60) Provisional application No. 61/247,199, filed on Sep. 30, 2009.

(30) Foreign Application Priority Data
Sep. 30, 2009 (DE) 10 2009 043 539.5

(51) Int. Cl. H01F 1/03; H01F 1/047; B22D 23/00; C21D 1/00; B22D 27/15

(52) U.S. Cl. 335/219; 335/302; 164/76.1; 148/557; 164/61; 164/66.1

(57) ABSTRACT

The invention relates to a magnetic strip, the strip having a magnetically easy direction axially parallel to a transverse axis of the strip. The strip is cut to length from a band of a magnetically semi-hard, crystalline alloy along a transverse axis of the band essentially corresponding to a width (b) of the strip. The band has a magnetically easy direction axially parallel to a longitudinal axis of the band.

This application claims the benefit under 37 C.F.R. §119 of the filing dates of U.S. Provisional Application No. 61/247,199 entitled MAGNETISCHER STREIFEN, SENSOR AUFWEISEND EINEN MAGNETISCHEN STREIFEN UND VERFAHREN ZUR HERSTELLUNG EINES MAGNETISCHEN STREIFENS, filed Sep. 30, 2009, and German Patent Application No. 10 2009 043 539.5, entitled MAGNETISCHER STREIFEN, SENSOR AUFWEISEND EINEN MAGNETISCHEN STREIFEN UND VERFAHREN ZUR HERSTELLUNG EINES MAGNETISCHEN STREIFENS, filed Sep. 30, 2009. The entire content of each being hereby incorporated herein by reference.

### BACKGROUND

1. Field

Disclosed herein a magnetic strip, a sensor comprising a magnetic strip and a process for the manufacture of a magnetic strip.

2. Description of Related Art

One embodiment of a display element for use in a magnetic theft protection system which comprises an elongated alarm strip of an amorphous ferromagnetic alloy and at least one activation strip of a semi-hard magnetic alloy is known from DE 197 32 872 A1.

### SUMMARY

Disclosed herein is a semi-hard magnetic alloy that contains 8 to 25% by weight Ni, 1.5 to 4.5% by weight Al, 0.5% by weight Ti and residual Fe. The alloy possesses very good magnetic properties and high corrosion resistance. Moreover, the alloy lends itself very well to cold forming prior to tempering.

Also disclosed herein is a magnetic strip, in particular for a sensor, and a process for the manufacture of a magnetic strip by which a preferred magnetic direction can be provided along a special axis of the strip, the strip itself being of simple manufacture.

In one embodiment is disclosed a magnetic strip, the strip having a magnetically easy direction axially parallel to a transverse axis of the strip. The strip is cut to length from a band of a magnetically semi-hard, crystalline alloy along a transverse axis of the band essentially corresponding to a width of the strip. The band has a magnetically easy direction axially parallel to a longitudinal axis of the band.

In this context ‘magnetically semi-hard’ is understood to mean alloys which are positioned between soft magnetic and hard magnetic in terms of coercive field strength. A ‘magnetically easy direction’ is understood to be the direction in which magnetisation work is least.

As the magnetic strip disclosed herein has a magnetically easy direction axially parallel to a transverse axis of the strip, the strip has a magnetically preferred magnetic direction perpendicular to a longitudinal axis of the magnetic strip. The magnetically preferred direction is thus arranged across the width of the strip. With this arrangement it is particularly easy to manufacture the magnetic strip with the magnetically easy direction parallel to its transverse axis by cutting the strip to length from the band of magnetically semi-hard, crystalline alloy with a magnetically easy direction parallel to its longitudinal axis along the transverse axis of the band essentially corresponding to the width of the strip. In a preferred embodiment the alloy has a composition which is reflected by the following general formula:

FeₐNi_{b}Al_{c}Ti_{d}CoₑMo_{f}Cr_{g}MₕM′ᵢ,

where M is at least one element selected from the group consisting of Zr, Hf, V, Nb, Ta, W, Mn and Si, where M′ is at least one element selected from the group consisting of C, N, S, P, B, H and O and where the coefficients a, b, c, d, e, f, g, h, i satisfy the following equations:

a+b+c+d+e+f+g+h+i=100(% by weight),

8.0≦b≦25.0,

1.5≦c≦4.5,

0.5≦d≦3.0,

0≦e≦5.0,

0≦f≦3.0,

0≦g≦3.0,

0≦h≦1.0 and

0≦i≦1.0.

The content of elements from the group from which M is selected is in each case less than 0.5% by weight. The content of elements from the group from which M′ is selected is in each case less than 0.2% by weight.

In a further embodiment:

13.0≦b≦17.0,

1.8≦c≦2.8,

1.5≦d≦1.5.

Magnetorestriction can be set in a particularly favourable manner by, in particular, reducing the aluminium content.

In a preferred embodiment the alloy has a coercive field strength H_{c} where 10 A/cm≦H_{c}≦24 A/cm.

In a further preferred embodiment the alloy has a remanence Bᵣ where 1.30 T≦Bᵣ≦1.6 T.

The alloys specified possess particularly good magnetic properties and high corrosion resistance. In addition, these alloys are highly ductile.

In a further preferred embodiment the alloy has a composition which is reflected by the following general formula:

FeₐNi_{b}M_{c}M′_{d},

where M is at least one element selected from the group consisting of Cr, W and V, where M′ is at least one element selected from the group consisting of C, N, S, P, B, H and O and where the coefficients a, b, c, d satisfy the following equations:

a+b+c+d=100(% by weight),

15≦b≦25,

2≦c≦8 and

0≦d≦1.

In a further embodiment:

4≦c≦8.

In a preferred embodiment the alloy has a coercive field strength H_{c} where 10 A/cm≦H_{c}≦25 A/cm.

In a further preferred embodiment the alloy has a remanence Bᵣ of at least 0.9 T.

In a further preferred embodiment the alloy has a composition which is reflected by the following general formula:

FeₐNi_{b}Mo_{c}M_{d}M′ₑ,

where M is at least one element selected from the group consisting of Cr, W and V, where M′ is at least one element selected from the group consisting of C, N, S, P, B, H and O and where the coefficients a, b, c, d, e satisfy the following equations:

a+b+c+d+e=100(% by weight),

15≦b≦25.0,

0<c≦3.5,

0<d≦8.0 and

0≦e≦1.0.

In a further embodiment:

0.5≦c≦2.8.

In a further embodiment:

1.0≦c≦2.8.

In a further embodiment:

0.5≦d≦8.0.

In a further embodiment:

0.5≦d≦5.0.

In a further embodiment:

2.0≦d≦4.0.

In a preferred embodiment the alloy has a coercive field strength H_{c} where 10 A/cm≦H_{c}≦25 A/cm.

In a further preferred embodiment the alloy has a remanence Bᵣ of at least 1.0 T.

In a further preferred embodiment the alloy has a composition which is reflected by the following general formula:

FeₐNi_{b}Mo_{c}M_{d}M′ₑ,

where M is at least one element selected from the group consisting of Mn and Si, where M′ is at least one element selected from the group consisting of C, N, S, P, B, H and O and where the coefficients a, b, c, d, e satisfy the following equations:

a+b+c+d+e=100(% by weight),

15≦b≦25.0,

0<c≦8.0,

0<d≦1.0 and

0≦e≦1.0.

In a further preferred embodiment the alloy has a composition which is reflected by the following general formula:

FeₐNi_{b}Cr_{c}Mo_{d}CoₑM′_{f},

where M is at least one element selected from the group consisting of C, N, S, P, B, H and O and where the coefficients a, b, c, d, e, f satisfy the following equations:

a+b+c+d+e+f=100(% by weight),

0.1≦b≦10.0,

0.1≦c≦15.0,

0.1≦d≦15.0,

0<e≦5.0 and

0≦f≦1.0.

In a further preferred embodiment the alloy has a composition which is reflected by the following general formula:

FeₐNi_{b}Cr_{c}Mo_{d}CoₑM_{f}M′_{g},

where M is at least one element selected from the group consisting of Mn, Si and Cu, where M′ is at least one element selected from the group consisting of C, N, S, P, B, H and O and where the coefficients a, b, c, d, e, f satisfy the following equations:

a+b+c+d+e+f+g=100(% by weight),

3.0≦b≦13.0,

10.0≦c≦16.0,

0.1≦d≦8.0,

3.0≦e≦13.0,

0≦f≦1.0 and

0≦g≦1.0.

In a further preferred embodiment the alloy has a composition which is reflected by the following general formula:

FeₐCo_{b}V_{c}Cr_{d}MₑM′_{f},

where M is at least one element selected from the group consisting of Ni, Mn, Si, Cu and Mo, where M′ is at least one element selected from the group consisting of C, N, S, P, B, H and O and where the coefficients a, b, c, d, e, f satisfy the following equations:

a+b+c+d+e+f=100(% by weight),

45≦b≦55,

5≦c≦15,

0<d≦5,

0≦e<1 and

0≦f≦1.

In a further preferred embodiment the alloy has a composition which is reflected by the following general formula:

FeₐCo_{b}Ni_{c}Al_{d}TiₑM_{f}M′_{g},

where M is at least one element selected from the group consisting of Cr, Mn, Si, Cu and Mo, where M′ is at least one element selected from the group consisting of C, N, S, P, B, H and O and where the coefficients a, b, c, d, e, f, g satisfy the following equations:

a+b+c+d+e+f+g=100(% by weight),

50≦b≦60,

5≦c≦15,

0<d≦5,

0<e≦5,

0≦f<1 and

0≦g≦1.

The width of the band can essentially correspond to a length of the strip. As a result the strip can be manufactured even more simply since the width of the band already corresponds to the length of the strip and so no further processing steps are required.

It is particularly preferable if the width of the strip is less than the length of the strip. Moreover, the equation 0 mm<d<0.1 mm preferably applies for a thickness (d) of the strip.

Also disclosed herein is a sensor, said sensor having at least one magnetic strip as disclosed in one of the preceding embodiments. The orientation of the magnetically easy direction along the transverse axis of the strip is particularly favourable in a sensor of this type.

Moreover, also disclosed herein is a process for the manufacture of a magnetic strip from a magnetically semi-hard, crystalline alloy, the strip having a magnetically easy direction axially parallel to a transverse axis of the strip. The process comprises the following steps. First a magnetically semi-hard alloy is melted and the molten alloy is cast to form an ingot. The ingot is then hot formed into a band and the band is cold formed essentially to a thickness of the strip to be manufactured by rolling the band in a direction of rolling. Moreover, a narrow band is produced by reducing a width of the rolled band essentially to a length of the strip to be manufactured, the width of the band being arranged perpendicular to the direction of rolling. Finally, the strip to be manufactured essentially corresponding to a width of the strip to be manufactured is separated from the narrow band along the width of the narrow band.

The process disclosed in the invention lends itself in a particularly favourable manner to the simple manufacture of the magnetic strip with a magnetically easy direction along the transverse axis of the strip. It can thus be used to manufacture a magnetic strip which has a magnetically preferred direction along a given axis of the strip.

In a preferred embodiment the alloy has a composition which is reflected by the following general formula:

FeₐNi_{b}Al_{c}Ti_{d}CoₑMo_{f}Cr_{g}MₕM′ᵢ,

where M is at least one element selected from the group consisting of Zr, Hf, V, Nb, Ta, W, Mn and Si, where M′ is at least one element selected from the group consisting of C, N, S, P, B, H and O and where the coefficients a, b, c, d, e, f, g, h, i satisfy the following equations:

a+b+c+d+e+f+g+h+i=100(% by weight),

8.0≦b≦25.0,

1.5≦c≦4.5,

0.5≦d≦3.0,

0≦e≦5.0,

0≦f≦3.0,

0≦g≦3.0,

0≦h≦1.0 and

0≦i≦1.0.

The content of elements from the group from which M is selected is in each case less than 0.5% by weight. The content of elements from the group from which M′ is selected is in each case less than 0.2% by weight.

In a further embodiment:

13.0≦b≦17.0,

1.8≦c≦2.8,

0.5≦d≦1.5.

Magnetorestriction can be set in a particularly favourable manner by, in particular, reducing the aluminium content.

In a preferred embodiment the alloy has a coercive field strength H_{c} where 10 A/cm≦H_{c}≦24 A/cm.

In a further preferred embodiment the alloy has a remanence Bᵣ where 1.30 T≦Bᵣ≦1.60 T.

The alloys specified possess particularly good magnetic properties and high corrosion resistance. In addition, these alloys are highly ductile and can be cold formed excellently prior to tempering, thereby making band cross-section reductions of more than 90% possible.

In a further preferred embodiment the alloy has a composition which is reflected by the following general formula:

FeₐNi_{b}M_{c}M′_{d},

where M is at least one element selected from the group consisting of Cr, W and V, where M′ is at least one element selected from the group consisting of C, N, S, P, B, H and O and where the coefficients a, b, c, d satisfy the following equations:

a+b+c+d=100(% by weight),

15≦b≦25,

2≦c≦8 and

0≦d≦1.

In a further embodiment:

4≦c≦8.

In a preferred embodiment the alloy has a coercive field strength H_{c} where 10 A/cm≦H_{c}≦25 A/cm.

In a further preferred embodiment the alloy has a remanence Bᵣ of at least 0.9 T.

In a further preferred embodiment the alloy has a composition which is reflected by the following general formula:

FeₐNi_{b}MO_{c}M_{d}M′ₑ,

where M is at least one element selected from the group consisting of Cr, W and V, where M′ is at least one element selected from the group consisting of C, N, S, P, B, H and O and where the coefficients a, b, c, d, e satisfy the following equations:

a+b+c+d+e=100(% by weight),

15.0≦b≦25.0,

0<c≦3.5,

0<d≦8.0 and

0≦e≦1.0.

In a further embodiment:

0.5≦c≦2.8.

In a further embodiment:

1.0≦c≦2.8.

In a further embodiment:

0.5≦d≦8.0.

In a further embodiment:

0.5≦d≦5.0.

In a further embodiment:

2.0≦d≦4.0.

In a preferred embodiment the alloy has a coercive field strength H_{c} where 10 A/cm≦H_{c}≦25 A/cm.

In a further preferred embodiment the alloy has a remanence Bᵣ of at least 1.0 T.

In a further preferred embodiment the alloy has a composition which is reflected by the following general formula:

FeₐNi_{b}Mo_{c}M_{d}M′ₑ,

where M is at least one element selected from the group consisting of Mn and Si, where M′ is at least one element selected from the group consisting of C, N, S, P, B, H and O and where the coefficients a, b, c, d, e satisfy the following equations:

a+b+c+d+e=100(% by weight),

15≦b≦25.0,

0<c≦8.0,

0<d<1.0 and

0≦e≦1.0.

In a further preferred embodiment the alloy has a composition which is reflected by the following general formula:

FeₐNi_{b}Cr_{c}Mo_{d}CoₑM′_{f},

where M is at least one element selected from the group consisting of C, N, S, P, B, H and O and where the coefficients a, b, c, d, e, f satisfy the following equations:

a+b+c+d+e+f=100(% by weight),

0.1≦b≦10.0,

0.1≦c≦15.0,

0.1≦d≦15.0,

0<e≦5.0 and

0≦f≦1.0.

In a further preferred embodiment the alloy has a composition which is reflected by the following general formula:

FeₐNi_{b}Cr_{c}Mo_{d}CoₑM_{f}M′_{g},

where M is at least one element selected from the group consisting of Mn, Si and Cu, where M′ is at least one element selected from the group consisting of C, N, S, P, B, H and O and where the coefficients a, b, c, d, e, f, g satisfy the following equations:

a+b+c+d+e+f+g=100(% by weight),

3.0≦b≦13.0,

10.0≦c≦16.0,

0.1≦d≦8.0,

3.0≦e≦13.0,

0≦f<1.0 and

0≦g≦1.0.

In a further preferred embodiment the alloy has a composition which is reflected by the following general formula:

FeₐCo_{b}V_{c}Cr_{d}MₑM′_{f},

where M is at least one element selected from the group consisting of Ni, Mn, Si, Cu and Mo, where M′ is at least one element selected from the group consisting of C, N, S, P, B, H and O and where the coefficients a, b, c, d, e, f satisfy the following equations:

a+b+c+d+e+f=100(% by weight),

45≦b≦55,

5≦c≦15,

0<d≦5,

0≦e≦1,

0≦f≦1, and

More particularly,

0≦e<1.

In a further preferred embodiment the alloy has a composition which is reflected by the following general formula:

FeₐCo_{b}Ni_{c}Al_{d}TiₑM_{f}M′_{g},

where M is at least one element selected from the group consisting of Cr, Mn, Si, Cu and Mo, where M′ is at least one element selected from the group consisting of C, N, S, P, B, H and O and where the coefficients a, b, c, d, e, f, g satisfy the following equations:

a+b+c+d+e+f+g=100(% by weight),

50≦b≦60,

5≦c≦15,

0<d≦5,

0<e≦5,

0≦f≦1 and

0≦g≦1.

More particularly,

0≦f<1.

In a further preferred embodiment of the process disclosed herein, the width of the strip to be manufactured is less than the length of the strip to be manufactured.

In addition, the thickness (d) of the strip to be manufactured preferably corresponds to the equation 0 mm<d<0.1 mm.

In a further embodiment of the process disclosed in the invention tempering takes place after the cold forming of the band. Tempering can take place before production of the narrow band and separation of the strip to be manufactured. Tempering can also take place after production of the narrow band and separation of the strip to be manufactured as a bulk material. In both embodiments tempering is preferably carried out at a temperature of approximately 480° C. The tempering step increases the coercive strength.

The narrow band may be produced by cutting the rolled band. In addition, the strip to be manufactured can be separated by means of cutting to length.

In a further embodiment production of the narrow band and separation of the strip to be manufactured are carried out simultaneously by means of stamping.

The alloy is preferably melted under vacuum or protective gas.

In a further embodiment the ingot is hot formed at a temperature in excess of approximately 800° C.

Between the hot forming of the ingot and the cold forming of the band, the band can also be process annealed. The band is preferably process annealed at a temperature in excess of approximately 800° C.

In one version of the process disclosed herein the cold forming of the band comprises a plurality of cold rolling steps. Here the band is preferably process annealed between the cold rolling steps. The process annealing of the band between the cold rolling steps is preferably carried out at a temperature of approximately 700° C.

Process annealing may be carried out in particular to achieve particularly favourable homogenisation and/or grain refinement, for forming and/or to create desired mechanical properties, in particular high ductility.

### BRIEF DESCRIPTION OF DRAWINGS

The products and processes disclosed herein are explained in greater detail below with reference to the attached figures.

FIG. 1 is a flow diagram showing manufacturing steps for a magnetic strip as disclosed in one embodiment herein.

FIG. 2 is a schematic diagram that shows the strip involving the separation of a magnetic strip to be manufactured from a band.

FIG. 3 is a schematic diagram that shows a magnetic strip and the band from which the strip is cut to length as disclosed in one embodiment herein.

### DETAILED DESCRIPTION OF SPECIFIC EMBODIMENTS

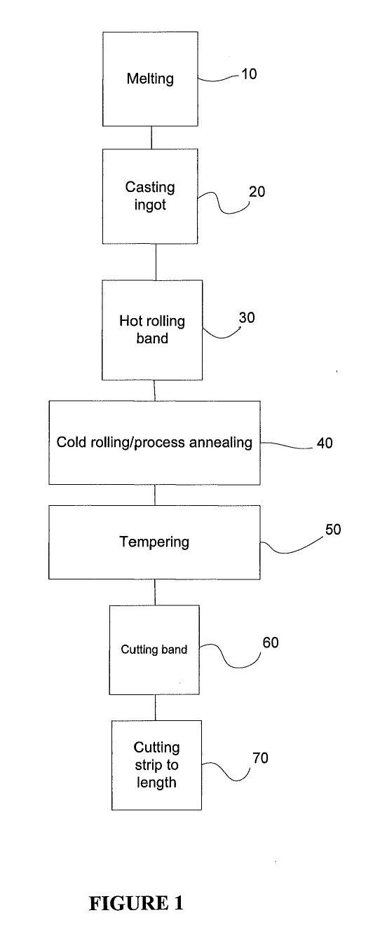

FIG. 1 shows a flow diagram with manufacturing steps for a magnetic strip as disclosed in one embodiment herein.

In a step 10a magnetically semi-hard alloy is melted in a crucible or furnace under vacuum or protective gas atmosphere. It is melted at a temperature of, for example, approximately 1600° C.

In a step 20 an ingot is then formed, for example in a round mould. In a further process step 30 the ingot is hot formed into a band, typically by means of hot rolling. In a further process step 40 the band is cold formed essentially to a thickness of the strip to be manufactured, for example by means of cold rolling the band in a direction of rolling. This cold forming of the band can comprise a plurality of cold rolling steps with the band being processed annealed between the cold rolling steps. The process annealing of the band between the cold rolling steps is carried out a temperature of, for example, approximately 700° C.

The band can also be process annealed between the ingot hot rolling step 30 and the band cold forming step 40, for example at a temperature in excess of approximately 800° C.

In a further process step 50 the cold rolled band is tempered, typically at a temperature of approximately 480° C.

In addition, in a step 60a narrow band is produced from the cold formed band by means of reducing a width of the rolled band essentially to a length of the strip to be manufactured, for example by means of cutting the band, the width of the band being arranged perpendicular to the direction of rolling.

In the embodiment shown, tempering is carried out prior to production of the narrow band and separation of the strip to be manufactured. It is also possible for tempering to be carried out after production of the narrow band and separation of the strip to be manufactured as bulk material.

In a further process step 70 the strip to be manufactured is separated from the narrow band essentially corresponding to a width of the strip to be manufactured along the width of the narrow band by means of cutting to length.

The alloy can have a composition which is reflected by the following general formula:

FeₐNi_{b}Al_{c}Ti_{d}CoₑMo_{f}Cr_{g}MₕM′ᵢ,

where M is at least one element selected from the group consisting of Zr, Hf, V, Nb, Ta, W, Mn and Si, where M′ is at least one element selected from the group consisting of C, N, S, P, B, H and O and where the coefficients a, b, c, d, e, f, g, h, i satisfy the following equations:

a+b+c+d+e+f+g+h+i=100(% by weight),

8.0≦b≦25.0,

1.5≦c≦4.5,

0.5≦d≦3.0,

0≦e≦5.0,

0≦f≦3.0,

0≦g≦3.0,

0≦h≦1.0 and

0≦i≦1.0.

The content of elements from the group from which M is selected is in each case less than 0.5% by weight. The content of elements from the group from which M′ is selected is in each case less than 0.2% by weight.

In a further embodiment:

13.0≦b≦17.0,

1.8≦c≦2.8,

1.5≦d≦1.5.

The alloy preferably has a coercive field strength H_{c} where 10 A/cm≦H_{c}≦24 A/cm.

Furthermore, the alloy has a remanence Bᵣ where 1.30 T≦Bᵣ≦1.60 T.

In a further preferred embodiment the alloy has a composition which is reflected by the following general formula:

FeₐNi_{b}M_{c}M′_{d},

where M is at least one element selected from the group consisting of Cr, W and V, where M′ is at least one element selected from the group consisting of C, N, S, P, B, H and O and where the coefficients a, b, c, d satisfy the following equations:

a+b+c+d=100(% by weight),

15≦b≦25,

2≦c≦8 and

0≦d≦1.

In a further embodiment:

4≦c≦8.

In a preferred embodiment the alloy has a coercive field strength H_{c} where 10 A/cm≦H_{c}≦25 A/cm.

In a further preferred embodiment the alloy has a remanence Bᵣ of at least 0.9 T.

In a further preferred embodiment the alloy has a composition which is reflected by the following general formula:

FeₐNi_{b}Mo_{c}M_{d}M′ₑ,

where M is at least one element selected from the group consisting of Cr, W and V, where M′ is at least one element selected from the group consisting of C, N, S, P, B, H and O and where the coefficients a, b, c, d, e satisfy the following equations:

a+b+c+d+e=100(% by weight),

15.0≦b≦25.0,

0<c≦3.5,

0<d≦8.0 and

0≦e≦1.0.

In a further embodiment:

0.5≦c≦2.8.

In a further embodiment:

1.0≦c≦2.8.

In a further embodiment:

0.5≦d≦8.0.

In a further embodiment:

0.5≦d≦5.0.

In a further embodiment:

2.0≦d≦4.0.

In a preferred embodiment the alloy has a coercive field strength H_{c} where 10 A/cm≦H_{c}≦25 A/cm.

In a further preferred embodiment the alloy has a remanence Bᵣ of at least 1.0 T.

In a further preferred embodiment the alloy has a composition which is reflected by the following general formula:

FeₐNi_{b}Mo_{c}M_{d}M′ₑ,

where M is at least one element selected from the group consisting of Mn and Si, where M′ is at least one element selected from the group consisting of C, N, S, P, B, H and O and where the coefficients a, b, c, d, e satisfy the following equations:

a+b+c+d+e=100(% by weight),

15≦b≦25.0,

0<c≦8.0,

0<d<1.0 and

0≦e≦1.0.

In a further preferred embodiment the alloy has a composition which is reflected by the following general formula:

FeₐNi_{b}Cr_{c}Mo_{d}CoₑM′_{f},

where M is at least one element selected from the group consisting of C, N, S, P, B, H and O and where the coefficients a, b, c, d, e, f satisfy the following equations:

a+b+c+d+e+f=100(% by weight),

0.1≦b≦10.0,

0.1≦c≦15.0,

0.1≦d≦15.0,

0<e≦5.0 and

0≦f≦1.0.

In a further preferred embodiment the alloy has a composition which is reflected by the following general formula:

FeₐNi_{b}Cr_{c}Mo_{d}CoₑM_{f}M′_{g},

where M is at least one element selected from the group consisting of Mn, Si and Cu, where M′ is at least one element selected from the group consisting of C, N, S, P, B, H and O and where the coefficients a, b, c, d, e, f, g satisfy the following equations:

a+b+c+d+e+f+g=100(% by weight),

3.0≦b≦13.0,

10.0≦c≦16.0,

0.1≦d≦8.0,

3.0≦e≦13.0,

0≦f≦1.0 and

0≦g≦1.0.

In a further preferred embodiment the alloy has a composition which is reflected by the following general formula:

FeₐCo_{b}V_{c}Cr_{d}MₑM′_{f},

where M is at least one element selected from the group consisting of Ni, Mn, Si and Cu, Mo, where M′ is at least one element selected from the group consisting of C, N, S, P, B, H and O and where the coefficients a, b, c, d, e, f satisfy the following equations:

a+b+c+d+e+f=100(% by weight),

45≦b≦55,

5≦c≦15,

0<d≦5,

0≦e<1 and

0≦f≦1.

In a further preferred embodiment the alloy has a composition which is reflected by the following general formula:

FeₐCo_{b}Ni_{c}Al_{d}TiₑM_{f}M′_{g},

where M is at least one element selected from the group consisting of Cr, Mn, Si, Cu and Mo, where M′ is at least one element selected from the group consisting of C, N, S, P, B, H and O and where the coefficients a, b, c, d, e, f, g satisfy the following equations:

a+b+c+d+e+f+g=100(% by weight),

50≦b≦60,

5≦c≦15,

0<d≦5,

0<e≦5,

0≦f<1 and

0≦g≦1.

The process disclosed in this embodiment of the invention lends itself particularly well to the manufacture of a magnetic strip which has excellent coercive strength H_{c} and very good remanence Bᵣ.

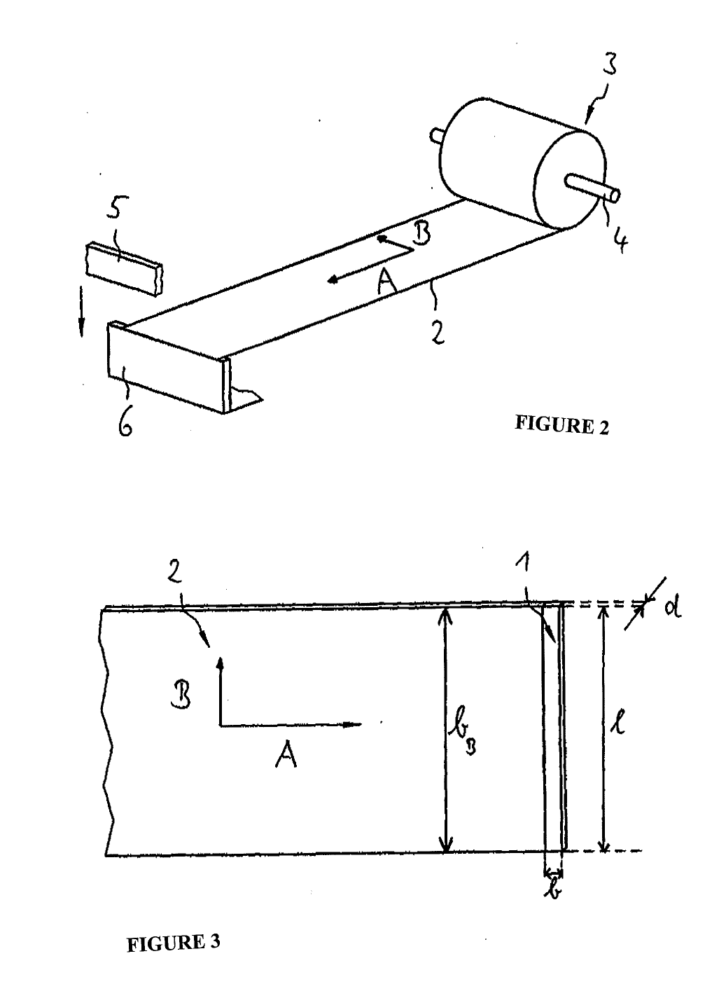

FIG. 2 shows the step in which a magnetic strip to be manufactured is separated from a band (2).

Here the band (2) which is partially rolled onto a roller (3) held by a shaft (4) is drawn off the roller (3). In this arrangement the band (2) consists of a magnetically semi-hard, crystalline alloy the composition of which has already been specified in connection with FIG. 1 and which has a magnetically easy direction axially parallel to a longitudinal axis of the band (2) which is illustrated schematically in FIG. 2 by the direction of an arrow (A) which also indicates the direction of rolling.

A magnetic strip (not shown in FIG. 2) is cut to length from the band (2) by means of the length-cutting devices (5 and 6). Here the lengths are cut along a transverse axis of the strip (1), which is illustrated schematically in FIG. 2 by the direction of arrow (B), essentially corresponding to the width of the strip.

FIG. 3 shows a magnetic strip (1) and the band (2) of a magnetically semi-hard, crystalline alloy from which the strip (1) is cut to length in accordance with an embodiment of the invention. Components with the same functions as in the previous figures are indicated using the same reference numerals and not discussed further in what follows.

The strip (1) is cut to length from the band (2) along the transverse axis of the band (2), which is illustrated schematically by the direction of arrow (B), corresponding to a width b of the strip (1). The band (2) has a magnetically easy direction axially parallel to its longitudinal axis which is illustrated schematically by the direction of the arrow (A). The magnetic strip (1) thus has a magnetically easy direction axially parallel to a transverse axis of the strip (1) which is also illustrated schematically by the direction of arrow (A).

In the embodiment shown a width (b_{B}) of the band (2) corresponds to a length (1) of the strip (1). Thus the strip (1) can be manufactured even more simply since the width (b_{B}) of the band (2) already corresponds to the length (1) of the band and further processing steps can therefore be omitted.

In the embodiment shown the equation 0 mm<d<0.1 mm applies to a thickness (d) of the strip (1).

The invention having been thus described with reference to certain specific embodiments and examples thereof, it will be understood that this is illustrative, and not limiting, of the appended claims.

1. A magnetic strip, comprising a magnetically easy direction axially parallel to a transverse axis of the strip, wherein the strip is cut to length from a band of a magnetically semi-hard, crystalline alloy along a transverse axis of the band, essentially corresponding to a width (b) of the strip, wherein the band has a magnetically easy direction axially parallel to a longitudinal axis of the band.

2. A magnetic strip in accordance with claim 1, wherein the magnetically semi-hard, crystalline alloy has a composition given by the formula:
FeₐNi_{b}Al_{c}Ti_{d}CoₑMo_{f}Cr_{g}MₕM′ᵢ,
wherein M is at least one element selected from the group consisting of Zr, Hf, V, Nb, Ta, W, Mn and Si, wherein M′ is at least one element selected from the group consisting of C, N, S, P, B, H and O and where the coefficients a, b, c, d, e, f, g, h, i satisfy the following equations:
a+b+c+d+e+f+g+h+i=100(% by weight),
8.0≦b≦25.0,
1.5≦c≦4.5,
0.5≦d≦3.0,
0≦e≦5.0,
0≦f≦3.0,
0≦g≦3.0,
0≦h≦1.0 and
0≦i≦1.0.

3. The magnetic strip in accordance with claim 2, wherein:
13.0≦b≦17.0,
1.8≦c≦2.8,
1.5≦d≦1.5.

4. The magnetic strip in accordance with claim 1, wherein the magnetically semi-hard, crystalline alloy has a coercive field strength H_{c} wherein 10 A/cm≦H_{c}≦24 A/cm.

5. The magnetic strip in accordance with claim 1, wherein the magnetically semi-hard, crystalline alloy has a remanence Bᵣ wherein 1.30 T≦Bᵣ≦1.60 T.

6. The magnetic strip in accordance with claim 1, wherein the magnetically semi-hard, crystalline alloy has a composition given by the formula:
FeₐNi_{b}M_{c}M′_{d},
wherein M is at least one element selected from the group consisting of Cr, W and V, wherein M′ is at least one element selected from the group consisting of C, N, S, P, B, H and O and wherein the coefficients a, b, c, d satisfy the following equations:
a+b+c+d=100(% by weight),
15≦b≦25,
2≦c≦8 and
0≦d≦1.

7. The magnetic strip in accordance with claim 6, wherein:
4≦c≦8.

8. The magnetic strip in accordance with claim 6, wherein the magnetically semi-hard, crystalline alloy has a coercive field strength H_{c} wherein 10 A/cm≦H_{c}≦25 A/cm.

9. The magnetic strip in accordance with claim 6, wherein the magnetically semi-hard, crystalline alloy having a remanence Bᵣ of at least 0.9 T.

10. The magnetic strip in accordance with claim 1, wherein the magnetically semi-hard, crystalline alloy has a composition given by the formula:
FeₐNi_{b}Mo_{c}M_{d}M′ₑ,
wherein M is at least one element selected from the group consisting of Cr, W and V, where M′ is at least one element selected from the group consisting of C, N, S, P, B, H and O and wherein the coefficients a, b, c, d, e satisfy the following equations:
a+b+c+d+e=100(% by weight),
15.0≦b≦25.0,
0<c≦3.5,
0<d≦8.0 and
0≦e≦1.0.

11. The magnetic strip in accordance with claim 10, wherein:
0.5≦c≦2.8.

12. The magnetic strip in accordance with claim 11, wherein:
1.0≦c≦2.8.

13. The magnetic strip in accordance with claim 10, wherein:
0.5≦d≦8.0.

14. The magnetic strip in accordance with claim 13, wherein:
0.5≦d≦5.0.

15. The magnetic strip in accordance with claim 14, wherein:
2.0≦d≦4.0.

16. The magnetic strip in accordance with claim 10, wherein the magnetically semi-hard, crystalline alloy has a coercive field strength H_{c} wherein 10 A/cm≦H_{c}≦25 A/cm.

17. The magnetic strip in accordance with claim 10, wherein the magnetically semi-hard, crystalline alloy has a remanence Bᵣ of at least 1.0 T.

18. The magnetic strip in accordance with claim 1, wherein the magnetically semi-hard, crystalline alloy has a composition given by the formula:
FeₐNi_{b}Mo_{c}M_{d}M′ₑ,
wherein M is at least one element selected from the group consisting of Mn and Si, wherein M′ is at least one element selected from the group consisting of C, N, S, P, B, H and O and wherein the coefficients a, b, c, d, e satisfy the following equations:
a+b+c+d+e=100(% by weight),
15≦b≦25.0,
0<c≦8.0,
0<d<1.0 and
0≦e≦1.0.

19. The magnetic strip in accordance with claim 1, wherein the magnetically semi-hard, crystalline alloy has a composition given by the formula:
FeₐNi_{b}Cr_{c}Mo_{d}CoₑM′_{f},
wherein M is at least one element selected from the group consisting of C, N, S, P, B, H and O and wherein the coefficients a, b, c, d, e, f satisfy the following equations:
a+b+c+d+e+f=100(% by weight),
0.1≦b≦10.0,
0.1≦c≦15.0,
0.1≦d≦15.0,
0<e≦5.0 and
0≦f≦1.0.

20. The magnetic strip in accordance with claim 1, wherein the magnetically semi-hard, crystalline alloy has a composition given by the formula:
FeₐNi_{b}Cr_{c}Mo_{d}CoₑM_{f}M′_{g},
wherein M is at least one element selected from the group consisting of Mn, Si and Cu, wherein M′ is at least one element selected from the group consisting of C, N, S, P, B, H and O and wherein the coefficients a, b, c, d, e, f satisfy the following equations:
a+b+c+d+e+f+g=100(% by weight),
3.0≦b≦13.0,
10.0≦c≦16.0,
0.1≦d≦8.0,
3.0≦e≦13.0,
0≦f<1.0 and
0≦g≦1.0.

21. The magnetic strip in accordance with claim 1, wherein the magnetically semi-hard, crystalline alloy has a composition given by the formula:
FeₐCo_{b}V_{c}Cr_{d}MₑM′_{f},
wherein M is at least one element selected from the group consisting of Ni, Mn, Si, Cu and Mo, wherein M′ is at least one element selected from the group consisting of C, N, S, P, B, H and O and wherein the coefficients a, b, c, d, e, f satisfy the following equations:
a+b+c+d+e+f=100(% by weight),
45≦b≦55,
5≦c≦15,
0<d≦5,
0≦e<1 and
0≦f≦1.

22. The magnetic strip in accordance with claim 1, wherein the magnetically semi-hard, crystalline alloy has a composition given by the formula:
FeₐCo_{b}Ni_{c}Al_{d}TiₑM_{f}M′_{g},
wherein M is at least one element selected from the group consisting of Cr, Mn, Si, Cu and Mo, wherein M′ is at least one element selected from the group consisting of C, N, S, P, B, H and O and wherein the coefficients a, b, c, d, e, f, g satisfy the following equations:
a+b+c+d+e+f+g=100(% by weight),
50≦b≦60,
5≦c≦15,
0<d≦5,
0<e≦5,
0≦f<1 and
0≦g≦1.

23. The magnetic strip in accordance with claim 1, wherein a width (b_{B}) of the band corresponds essentially to a length of the strip.

24. The magnetic strip in accordance with claim 1, wherein the width (b) of the strip is less than the length (1) of the strip.

25. The magnetic strip in accordance with claim 1, wherein the equation 0 mm<d<0.1 mm applies for a thickness (d) of the strip.

26. A sensor comprising at least one magnetic strip in accordance with claim 1.

27. A process for the manufacture of a magnetic strip of a magnetically semi-hard, crystalline alloy, the strip having a magnetically easy direction axially parallel to a transverse axis of the strip, comprising:
melting of a magnetically semi-hard alloy;
casting the molten alloy to form an ingot;
hot forming the ingot into a band;
cold forming of the band essentially to a thickness of the strip to be manufactured by rolling the band in a direction of rolling;
producing a narrow band by reducing a width of the rolled band essentially to a length of the strip to be manufactured, the width of the band being arranged perpendicular to the direction of rolling; and
separating the strip to be manufactured corresponding essentially to a width of the strip to be manufactured from the narrow band along the width of the narrow band.

28. The process in accordance with claim 27, wherein the magnetically semi-hard, crystalline alloy has a composition which is given by the formula:
FeₐNi_{b}Al_{c}Ti_{d}CoₑMo_{f}Cr_{g}MₕM′ᵢ,
wherein M is at least one element selected from the group consisting of Zr, Hf, V, Nb, Ta, W, Mn and Si, wherein M′ is at least one element selected from the group consisting of C, N, S, P, B, H and O and wherein the coefficients a, b, c, d, e, f, g, h, i satisfy the following equations:
a+b+c+d+e+f+g+h+i=100(% by weight),
8.0≦b≦25.0,
1.5≦c≦4.5,
0.5≦d≦3.0,
0≦e≦5.0,
0≦f≦3.0,
0≦g≦3.0,
0≦h≦1.0 and
0≦i≦1.0.

29. The process in accordance with claim 28, wherein:
13.0≦b≦17.0,
1.8≦c≦2.8,
1.5≦d≦1.5.

30. The process in accordance with claim 27, wherein the magnetically semi-hard, crystalline alloy has a coercive field strength H_{c} wherein 10 A/cm≦H_{c}≦24 A/cm.

31. The process in accordance with claim 27, wherein the magnetically semi-hard, crystalline alloy has a remanence Bᵣ wherein 1.30 T Bᵣ≦1.6 T.

32. The process in accordance with claim 27, wherein the magnetically semi-hard, crystalline alloy has a composition given by the formula:
FeₐNi_{b}M_{c}M′_{d},
wherein M is at least one element selected from the group consisting of Cr, W and V, wherein M′ is at least one element selected from the group consisting of C, N, S, P, B, H and O and wherein the coefficients a, b, c, d satisfy the following equations:
a+b+c+d=100(% by weight),
15≦b≦25,
2≦c≦8 and
0≦d≦1.

33. The process in accordance with claim 32, wherein:
4≦c≦8.

34. The process in accordance with claim 32, wherein the magnetically semi-hard, crystalline alloy has a coercive field strength H_{c} wherein 10 A/cm≦H_{c}≦25 A/cm.

35. The process in accordance with claim 32, the magnetically semi-hard, crystalline alloy has a remanence Bᵣ of at least 0.9 T.

36. The process in accordance with claim 27, wherein the magnetically semi-hard, crystalline alloy has a composition given by the formula:
FeₐNi_{b}Mo_{c}M_{d}M′ₑ,
wherein M is at least one element selected from the group consisting of Cr, W and V, wherein M′ is at least one element selected from the group consisting of C, N, S, P, B, H and O and wherein the coefficients a, b, c, d, e satisfy the following equations:
a+b+c+d+e=100(% by weight),
15.0≦b≦25.0,
0<c≦3.5,
0<d≦8.0 and
0≦e≦1.0.

37. The process in accordance with claim 36, wherein 0.5≦c≦2.8.

38. The process in accordance with claim 37, wherein 1.0≦c≦2.8.

39. The process in accordance with claim 36, wherein 0.5≦d≦8.0.

40. The process in accordance with claim 39, wherein 0.5≦d≦5.0.

41. The process in accordance with claim 40, wherein 2.0≦d≦4.0.

42. The process in accordance with claim 36, wherein the magnetically semi-hard, crystalline alloy has a coercive field strength H_{c} where 10 A/cm≦H_{c}≦25 A/cm.

43. The process in accordance with claim 36, wherein the magnetically semi-hard, crystalline alloy has a remanence Bᵣ of at least 1.0 T.

44. The process in accordance with claim 27, wherein the magnetically semi-hard, crystalline alloy has a composition given by the formula:
FeₐNi_{b}Mo_{c}M_{d}M′ₑ,
wherein M is at least one element selected from the group consisting of Mn and Si, wherein M′ is at least one element selected from the group consisting of C, N, S, P, B, H and O and wherein the coefficients a, b, c, d, e satisfy the following equations:
a+b+c+d+e=100(% by weight),
15≦b≦25.0,
0<c≦8.0,
0<d<1.0 and
0≦e≦1.0.

45. The process in accordance with claim 27, wherein the magnetically semi-hard, crystalline alloy has a composition given by the formula:
FeₐNi_{b}Cr_{c}Mo_{d}CoₑM′_{f},
wherein M is at least one element selected from the group consisting of C, N, S, P, B, H and O and wherein the coefficients a, b, c, d, e, f satisfy the following equations:
a+b+c+d+e+f=100(% by weight),
0.1≦b≦10.0,
0.1≦c≦15.0,
0.1≦d≦15.0,
0<e≦5.0 and
0≦f≦1.0.

46. The process in accordance with claim 27, wherein the magnetically semi-hard, crystalline alloy has a composition which is reflected by the following general formula:
FeₐNi_{b}Cr_{c}Mo_{d}CoₑM_{f}M′_{g},
wherein M is at least one element selected from the group consisting of Mn, Si and Cu, wherein M′ is at least one element selected from the group consisting of C, N, S, P, B, H and O and wherein the coefficients a, b, c, d, e, f, g satisfy the following equations:
a+b+c+d+e+f+g=100(% by weight),
3.0≦b≦13.0,
10.0≦c≦16.0,
0.1≦d≦8.0,
3.0≦e≦13.0,
0≦f<1.0 and
0≦g≦1.0.

47. The process in accordance with claim 27, wherein the magnetically semi-hard, crystalline alloy has a composition given by the formula:
FeₐCo_{b}V_{c}Cr_{d}MₑM′_{f},
wherein M is at least one element selected from the group consisting of Ni, Mn, Si, Cu and Mo, wherein M′ is at least one element selected from the group consisting of C, N, S, P, B, H and O and wherein the coefficients a, b, c, d, e, f satisfy the following equations:
a+b+c+d+e+f=100(% by weight),
45≦b≦55,
5≦c≦15,
0<d≦5,
0≦e<1 and
0≦f≦1.

48. The process in accordance with claim 27, wherein the magnetically semi-hard, crystalline alloy has a composition given by the formula:
FeₐCo_{b}Ni_{c}Al_{d}TiₑM_{f}M′_{g},
wherein M is at least one element selected from the group consisting of Cr, Mn, Si, Cu and Mo, wherein M′ is at least one element selected from the group consisting of C, N, S, P, B, H and O and wherein the coefficients a, b, c, d, e, f, g satisfy the following equations:
a+b+c+d+e+f+g=100(% by weight),
50≦b≦60,
5≦c≦15,
0<d≦5,
0<e≦5,
0≦f<1 and
0≦g≦1.

49. The process in accordance with claim 27, wherein the width of the strip to be manufactured is less than the length of the strip to be manufactured.

50. The process in accordance with claim 27, wherein the equation 0 mm<d<0.1 mm applies to a thickness (d) of the strip to be manufactured.

51. The process in accordance with claim 27, further comprising tempering after cold forming.

52. The process in accordance with claim 51, wherein the tempering occurs prior to production of the narrow band and separation of the strip to be manufactured.

53. The process in accordance with claim 51, wherein the tempering occurs after production of the narrow band and separation of the strip to be manufactured as bulk material.

54. The process in accordance with claim 51, wherein the tempering occurs at a temperature of approximately 480° C.

55. The process in accordance with claim 27, wherein producing the narrow band comprises cutting the rolled band.

56. The process in accordance with claim 27, wherein separating the strip to be manufactured comprises cutting to length.

57. The process in accordance with claim 27, wherein producing the narrow band and separating the strip to be manufactured occur simultaneously by means of stamping.

58. The process in accordance with claim 27, wherein the melting occurs under vacuum.

59. The process in accordance with claim 27, wherein the melting occurs under protective gas.

60. The process in accordance with claim 27, wherein the hot forming of the ingot occurs at a temperature in excess of approximately 800° C.

61. The process in accordance with claim 27, further comprising process annealing the band between the hot forming of the ingot and the cold forming of the band.

62. The process in accordance with claim 61, wherein the process annealing of the band occurs at a temperature in excess of approximately 800° C.

63. The process in accordance with claim 27, wherein the cold forming of the band comprises a plurality of cold rolling steps.

64. The process in accordance with claim 63, further comprising process annealing the band between the cold rolling steps.

65. The process in accordance with claim 64, wherein the process annealing of the band between the cold rolling steps occurs at approximately 700° C.
